(19) United States
(12) Patent Application Publication
(10) Pub. No.: US 2016/0312943 A1
(43) Pub. Date: Oct. 27, 2016

(54) MOUNT AND SATELLITE ANTENNA MODULE THEREWITH

(71) Applicant: Wistron NeWeb Corporation, Hsinchu (TW)

(72) Inventor: Lan-Chun Yang, Hsinchu (TW)

(21) Appl. No.: 14/918,573

(22) Filed: Oct. 21, 2015

(30) Foreign Application Priority Data
Apr. 24, 2015 (TW) 104113160

(51) Int. Cl. F16M 11/18; F16M 13/02; H01Q 1/12

(52) U.S. Cl. CPC F16M 11/18; H01Q 1/1214; F16M 13/02

(57) ABSTRACT

A satellite antenna module includes a mount, a supporting frame disposed on the mount, and a satellite disk disposed on the supporting frame. The mount includes a base, a first adjusting mechanism, a first pressing member, a second adjusting mechanism, and a second pressing member. The first and second adjusting mechanisms are oppositely disposed on the base. The first and second pressing members are disposed on the first and second adjusting mechanisms respectively. When the base is placed on an edge portion of a structural object, the first and second adjusting mechanisms can be individually operated to move the first and second pressing members toward each other to clamp the edge portion. Thereby, the mount can be easily attached onto edge portions with various geometric profiles.

### BACKGROUND OF THE INVENTION

1. Field of the Invention

The invention relates to a fixing structure, and especially relates to a fixing structure for fixing an antenna.

2. Description of the Prior Art

Satellite antennas commonly are disposed outside. For abetter quality of receiving signals, the antenna is usually disposed through a fixing support on a roof or a parapet or railing on a top floor. The fixing support is usually joined onto a wall surface or a railing surface by an anchoring method (such as by anchor bolts, expansion bolts and so on), so that the antenna can be firmly disposed. However, anchoring structures require cooperation with buildings which are usually required to provide a flat surface with a certain area for the cooperation. The anchoring structure will cause a permanent damage on the building, which increases the difficulty in installing the antenna. In addition, in general, the joining of the anchoring structure with the building is a one-off connection; that is, the anchoring structure cannot be reused, so a new anchorage is required for re-disposing the fixing support.

### SUMMARY OF THE INVENTION

An objective of the invention is to provide a mount and a satellite antenna module with the mount. The mount uses a reusable clamping mechanism, which facilitates disposing or re-disposing the mount and avoids damage to a structural object where the mount is disposed.

A mount according to the invention is used for being fixed across on an edge portion of a structural object and supporting a device. The mount includes a base, a first adjusting mechanism, a first pressing member, a second adjusting mechanism, and a second pressing member. The device is disposed on the base. The first adjusting mechanism is disposed on the base. The first pressing member is disposed on the first adjusting mechanism. The first adjusting mechanism is operable to move the first pressing member relative to the base. The second adjusting mechanism is disposed on the base opposite to the first adjusting mechanism. The second pressing member is disposed on the second adjusting mechanism. The second adjusting mechanism is operable to move the second pressing member relative to the base. Therein, when the base is placed on the edge portion, the first adjusting mechanism and the second adjusting mechanism can be operated to move the first pressing member and the second pressing member toward each other at two opposite sides of the edge portion to clamp the edge portion. Thereby, the mount can be firmly fixed on the structural object, so that the device is firmly disposed on the edge portion of the structural object through the mount. In practice, a user can easily operate the first adjusting mechanism and the second adjusting mechanism for attaching the mount on the structural object or detaching the mount from the structural object, during which the structural object will not be damaged.

A satellite antenna module according to the invention includes a mount, a supporting frame, and a satellite disk. The mount is used for being fixed across on an edge portion of a structural object and includes a base, a first adjusting mechanism, a first pressing member, a second adjusting mechanism, and a second pressing member. The first adjusting mechanism is disposed on the base. The first pressing member is disposed on the first adjusting mechanism. The first adjusting mechanism is operable to move the first pressing member relative to the base. The second adjusting mechanism is disposed on the base opposite to the first adjusting mechanism. The second pressing member is disposed on the second adjusting mechanism. The second adjusting mechanism is operable to move the second pressing member relative to the base. The supporting frame is disposed on the base. The satellite disk is disposed on the supporting frame so that the satellite disk is supported on the mount through the supporting frame. Therein, when the base is placed on the edge portion, the first adjusting mechanism and the second adjusting mechanism can be operated to move the first pressing member and the second pressing member toward each other at two opposite sides of the edge portion to clamp the edge portion, so that the satellite disk is supported on the edge portion through the supporting frame and the mount. Thereby, in practice, a user can easily use the mount to dispose or re-dispose the satellite antenna module, and the structural object where the mount is disposed can avoid damage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a satellite antenna module, installed on a structural object, of an embodiment according to the invention.

FIG. 2 is schematic diagram illustrating a mount of the satellite antenna module in FIG. 1 from another viewpoint.

FIG. 3 is an exploded view of the mount in FIG. 2.

FIG. 4 is a sectional view of the mount in FIG. 1 installed on the structural object.

FIG. 5 is a sectional view of the mount in FIG. 1 installed on an edge portion of another structural object.

FIG. 6 is a schematic diagram illustrating a mount of another embodiment according to the invention.

FIG. 7 is a partially-exploded view of the mount in FIG. 6.

FIG. 8 is a side view of a first adjusting mechanism of the mount in FIG. 6.

FIG. 9 is an exploded view of a pressing member having a V-shaped recess.

FIG. 10 is a schematic diagram illustrating that the mount in FIG. 6, of which the pressing members are replaced with the pressing member in FIG. 9, is fixed across on an edge portion of a structural object.

### DETAILED DESCRIPTION

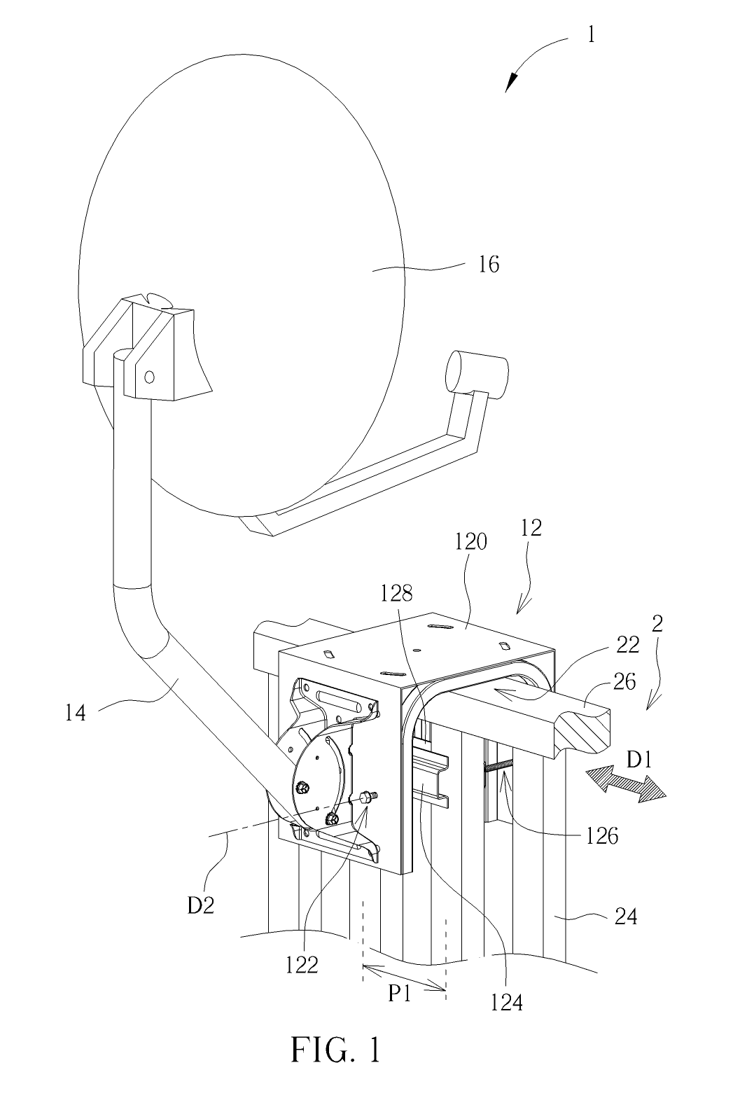

Please refer to FIG. 1, which is a schematic diagram illustrating a satellite antenna module 1, installed on a structural object 2, of an embodiment according to the invention. The satellite antenna module 1 includes a mount 12, a supporting frame 14, and a satellite disk 16. The mount 12 is fixed across on an edge portion 22 of the structural object 2. The supporting frame 14 is disposed on the mount 12. The satellite disk 16 is disposed on the supporting frame 14 so that the satellite disk 16 is supported on the mount 12 through the supporting frame 14. Thereby, the satellite antenna module 1 is installed on the structural object 2 by use of the mount 12. In the embodiment, the structural object 2 is a railing on a top floor, but the invention is not limited thereto. For example, in practice, the structural object 2 can be a parapet or other structural objects on which the mount 12 can be disposed across, and the material of the structural object 2 is not limited to cement, rock, wood or metal.

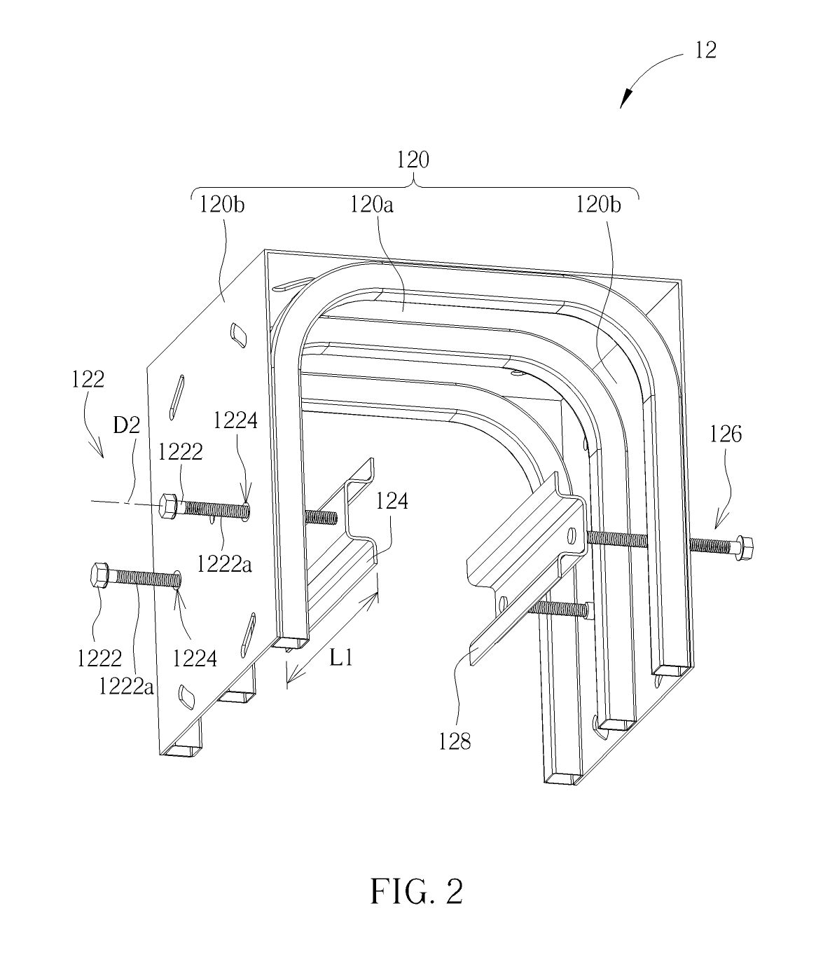

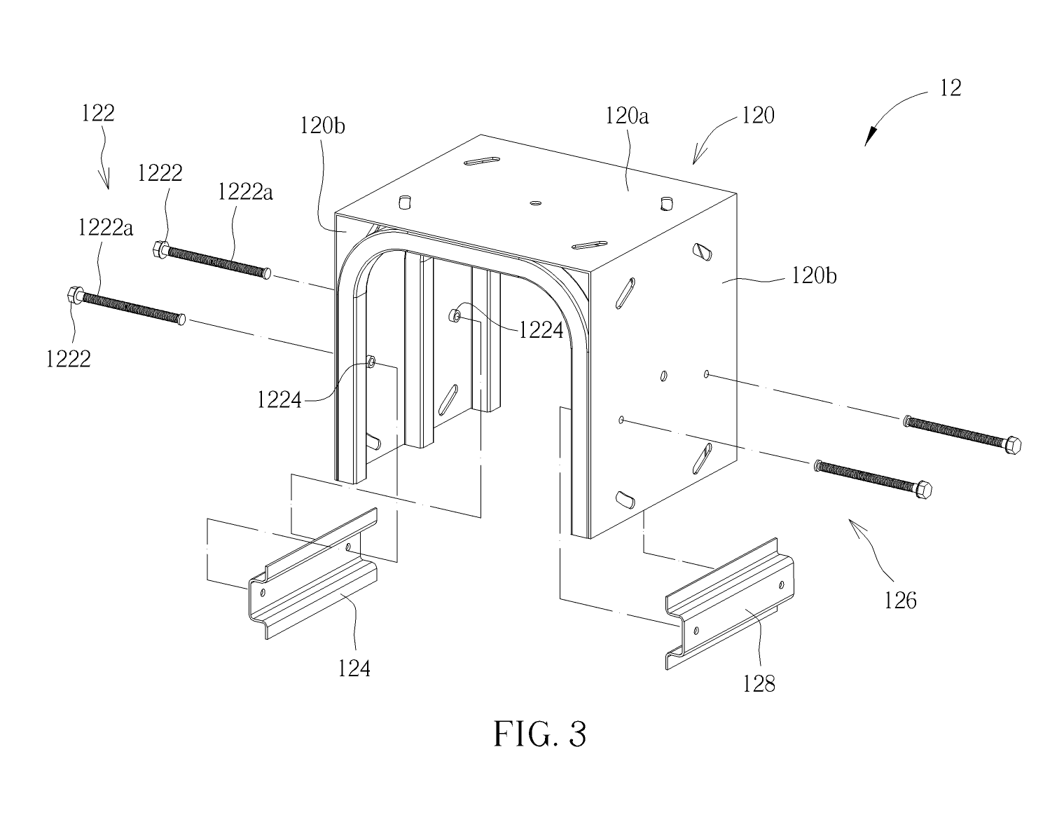

Please also refer to FIG. 2 and FIG. 3. FIG. 2 is schematic diagram illustrating the mount 12 in FIG. 1 from another viewpoint. FIG. 3 is an exploded view of the mount 12. The mount 12 includes a base 120, a first adjusting mechanism 122, a first pressing member 124, a second adjusting mechanism 126, and a second pressing member 128. The supporting frame 14 is disposed on the base 120. In the embodiment, the supporting frame 14 is directly fixed on the base 120 by screws, but the invention is not limited thereto. The first adjusting mechanism 122 and the second adjusting mechanism 126 are oppositely disposed on the base 120. The first pressing member 124 is disposed on the first adjusting mechanism 122. The first adjusting mechanism 122 is operable to move the first pressing member 124 relative to the base 120. The second pressing member 128 is disposed on the second adjusting mechanism 126. The second adjusting mechanism 126 is operable to move the second pressing member 128 relative to the base 120. Therein, when the base 120 is placed on the edge portion 22, the first adjusting mechanism 122 and the second adjusting mechanism 126 can be operated to move the first pressing member 124 and the second pressing member 128 toward each other at two opposite sides of the edge portion 22 to clamp the edge portion 22, so that the purpose of fixing the mount 12 on the structural object 2 is achieved.

For more details, in the embodiment, the first adjusting mechanism 122 includes a movable member and a matching part. The matching part is fixed on the base 120. The movable member is adjustably engaged with the matching part. The first pressing member 124 is connected to the movable member. Thereby, the movement of the first pressing member 124 relative to the base 120, i.e., the adjustment to the relative position can be obtained. Therein, the movable member is achieved by two bolts 1222. Each bolt 1222 has a screw portion 1222a thereon. The matching part is achieved by two threaded holes 1224 correspondingly. Each bolt 1222 meshes with the threaded hole 1224 through its screw portion 1222a, so that the bolt 1222 and the threaded hole 1224 move relatively when the screw portion 1222a and the threaded hole 1224 rotate relatively. Furthermore, the threaded hole 1224 is formed directly on the base 120, but the invention is not limited thereto. For example, the threaded hole 1224 also can be achieved by embedding a nut in the base 120 or by fixing a structural part with a threaded hole on the base 120. Thereby, in the embodiment, a user can adjust a position of the bolt 1222 relative to the base 120 by rotating the bolt 1222. The first pressing member 124 is pivotally connected to bolt 1222, for example, retaining the first pressing member 124 at the end of the bolt 1222 with a clip, which facilitates that the first pressing member 124 keeps the same orientation when the bolt 1222 rotates. Thereby, the first pressing member 124 can press the edge portion 22 firmly; however, the invention is not limited thereto.

Moreover, in the embodiment, the first adjusting mechanism 122 is achieved by two sets of one bolt 1222 plus one threaded hole 1224. This disposition improves the stability of force loading to the first pressing member 124 and also facilitates that the first pressing member 124 can press the edge portion 22 stably without interference with a portion of the supporting frame 14 connected to the base 120 (as shown by FIG. 1). In this case, the user needs to rotate the two blots 1222 for adjusting the position of the first pressing member 124 relative to the base 120. However, the invention is not limited thereto. For example, if the above interference problem is not under consideration or the above interference problem is solved by another method, the first adjusting mechanism 122 can be achieved by a set of one bolt 1222 plus one threaded hole 1224 so that the adjustment to the first pressing member 124 and the movement of the first pressing member 124 being driven to press the edge portion 22 also can be obtained. Furthermore, in practice, the movement of the bolt 1222 relative to the threaded hole 1224 also can be achieved by moving the threaded hole 1224 relative to the screw portion 1222a. For example, a bearing is fixed on the base 120, and an inner ring of the bearing is provided with a threaded hole structure thereon. Thereby, the threaded hole structure rotates relative to the screw portion 1222a when the inner ring rotates.

In addition, in the embodiment, the movable member and the matching part of the first adjusting mechanism 122 are achieved by the bolt 1222 and the threaded hole 1224, but the invention is not limited thereto. For example, the movable member is achieved by a rack, and the matching part is achieved by a worm meshing with the rack. The rack can be moved relative to the base 120 by rotating the worm, so that the adjustment to the position of the first pressing member 124 relative to the base 120 can be achieved. In addition, in the embodiment, for simplicity, the first adjusting mechanism 122 and the second adjusting mechanism 126 are structurally the same and symmetrically disposed on the base 120. Therefore, for descriptions of the second adjusting mechanism 126, please refer to the relevant descriptions of the first adjusting mechanism 122, which will not be repeated in addition. However, the invention is not limited thereto.

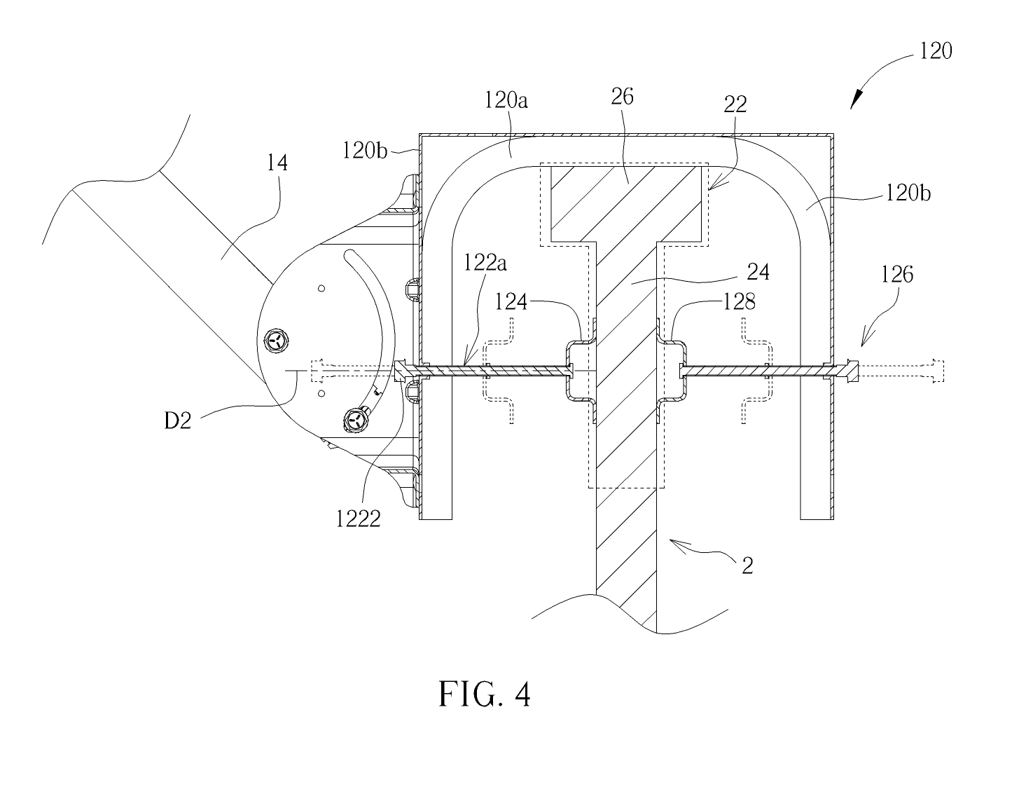

Please also refer to FIG. 4. FIG. 4 is a sectional view of the mount 12 installed on the structural object 2. In the embodiment, the base 120 is disposed across on the edge portion 22, so that the first pressing member 124 and the second pressing member 128 are located at the two opposite sides of the edge portion 22. By operating the first adjusting mechanism 122 and the second adjusting mechanism 126 (i.e. rotating the bolts 1222), the first pressing member 124 and the second pressing member 128 can tightly press the two opposite sides of the edge portion 22 to clamp the edge portion 22. The mount 12 is therefore fixed on the edge portion 22. When the mount 12 is required to be detached from the edge portion 22 (e.g. for re-disposing or storage), the first pressing member 124 and the second pressing member 128 can depart from the side surfaces of the edge portion 22 (as shown in dashed lines in FIG. 4) by operating the first adjusting mechanism 122 and the second adjusting mechanism 126 (i.e. rotating the bolts 1222).

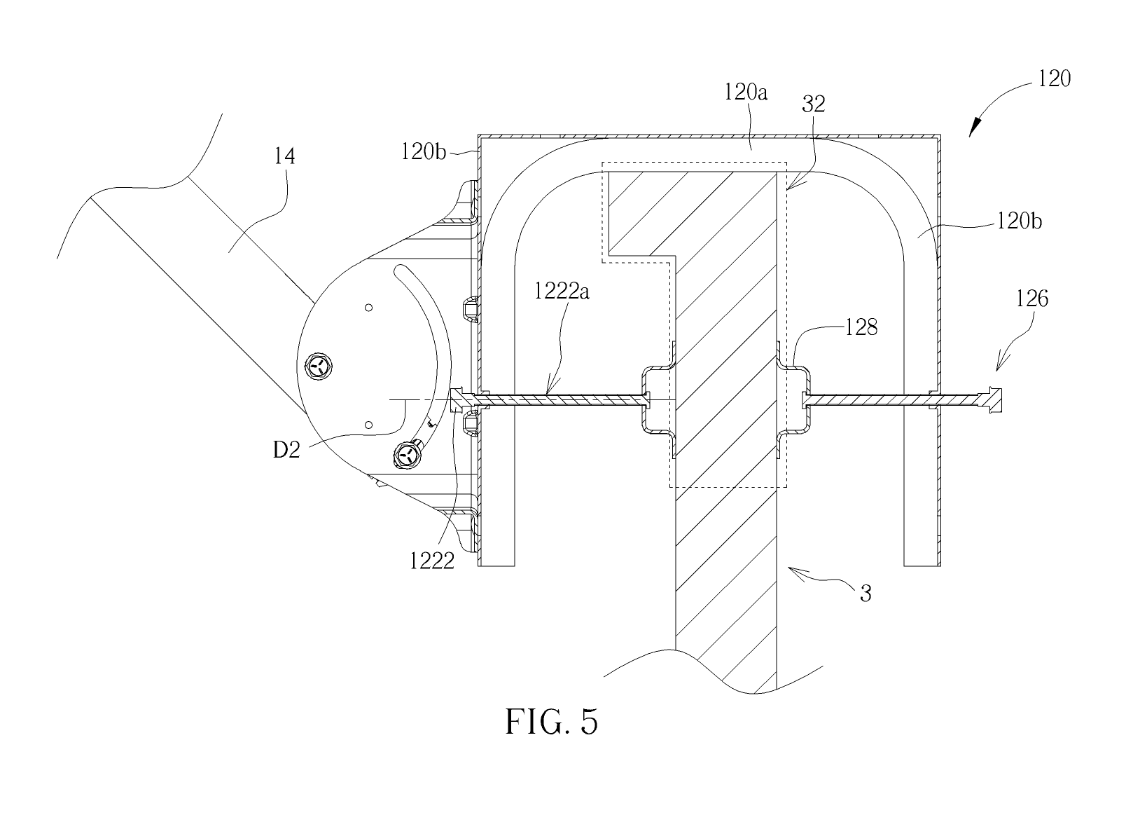

Furthermore, in the embodiment, the structural object 2 is, for example, a railing of cement and includes a plurality of posts 24, fixed on the ground, and a rail 26, connecting ends of the posts 24. The plurality of posts 24 are arranged in an interval P1 along an arrangement direction D1 (indicated by a bidirectional arrow in FIG. 1). Therefore, the edge portion 22 (indicated by a closed geometric profile in dashed lines in FIG. 4) of the structural object 2 for disposing the mount 12 thereon includes the rail 26 and the portions of the posts 24 connected to the rail 26. In the embodiment, although the edge portion 22 shows a T-shaped sectional profile, based on that the first pressing member 124 and the second pressing member 128 can be adjusted relative to the base 120, the first pressing member 124 and the second pressing member 128 still can be located at the two opposite sides of the posts 24 and tightly press the posts 24 when the base 120 is placed on the rail 26. In another aspect, the mount 12 can be applied to edge portions with various geometric profiles. For example, as shown by FIG. 5, the mount 12 is installed on an edge portion 32 of another structural object 3. Therein, although the edge portion 32 shows a reverse L-shaped sectional profile, based on the feature of the adjustment to the first pressing member 124 and the second pressing member 128, the first pressing member 124 and the second pressing member 128 still can oppositely press the edge portion 32 efficiently, so that the mount 12 can be firmly fixed on the edge portion 32. Furthermore, according to the above descriptions, it is obvious that the mount 12 also can be installed on an edge portion showing a rectangular sectional profile, which will not be repeated in addition.

Furthermore, in the embodiment, when the mount 12 has been installed on the edge portion 22, the first pressing member 124 can be treated logically as extending in the arrangement direction D1 in which the plurality of posts 24 are arranged. The first pressing member 124 has a length L1 in the arrangement direction D1. In a practical operation of installing the mount 12 onto the edge portion 22, if the length L1 of the first pressing member 124 is less than two intervals P1 and the middle of the first pressing member 124 is not aligned with one of the posts 24, it is workable to adjust the position of the mount 12 relative to the edge portion such that the first pressing member 124 can press two or more posts 24 at the same time so that the middle of the first pressing member 124 is located between the two posts 24. Therefore, the stability of the first pressing member 124 pressing the edge portion 22 can be improved. In this case, the middle of the first pressing member 124 is not aligned with one of the posts 24 (i.e. the first pressing member 124 is not symmetrically disposed relative to the post 24), so the first pressing member 124 presses the two adjacent posts 24. In principle, the first pressing member 124 can press two adjacent posts 24 if the length L1 is larger than the interval P1 (or a calculation of subtracting the width of the post 24 in the arrangement direction D1 from the interval P1, if the width of the post 24 is under consideration). In practice, for example, if the mount 12 can be provided with the length L1 larger than 1.5 times the interval P1, the first pressing member 124 can press the posts 24 firmly land reliably.

In addition, as shown by FIG. 2 and FIG. 4, in the embodiment, the base 120 includes a connection portion 120a and two side portions 120b. The two side portions 120b are oppositely connected to the connection portion 120a to for a reverse U-shaped structure. Therein, the base 120 is formed by a bent metal plate with a plurality of ribs thereon, but the invention is not limited thereto. For example, the base 120 is formed by bending a thicker metal plate in a reverse U-shaped structure, or by a bent metal plate that is also pressed to form reinforcement ribs thereon. For another example, the base 120 is formed by an assembly of three parts. In the embodiment, the base 120 is disposed across the edge portion 22 of the structural object 2 through the reverse U-shaped structure. The first adjusting mechanism 122 and the second adjusting mechanism 126 are disposed on the two side portions 120b respectively (e.g. the threaded holes 1224 are directly formed on the side portions 120b). The first pressing member 124 and the second pressing member 128 are located between the two side portions 120b. It is added that the reverse U-shaped structure forms an accommodating space, in which the edge portion 22 is accommodated when the mount 12 is installed on the edge portion 22. From a viewpoint of the structural configuration, the mount 12 is installed on the edge portion 22 by straddling the edge portion 22, which enhances the installation stability of the mount 12. In practice, the base 120 can be formed by a single part that is cut to form an open channel forming an accommodating space thereon like the accommodating space, so that the single part can straddle the edge portion 22 of the structural object 2 through the open channel.

As described above, the mount 12 according to the invention will not damage the edge portion 22 when installed onto the edge portion 22, so the edge portion 22 is only required to be capable of suffering pressing force by the first pressing member 124 and the second pressing member 128. Whether the interior structure of the edge portion 22 is dense or not will not affect the installation of the mount 12. Furthermore, when the mount 12 is required to be detached or re-disposed from the edge portion 22, the user also can operate the first adjusting mechanism 122 and the second adjusting mechanism 126 to move the first pressing member 124 and the second pressing member 128 away from each other, so that the mount 12 can be moved relative to the edge portion 22. Because the edge portion 22 is not structurally damaged when the mount 12 is installed onto the edge portion 22 or after the mount 12 is detached from the edge portion 22, and the mount 12 is not structurally damaged either, so the edge portion 22 is still in good condition, and the mount 12 also can be easily fixed at other places. Therefore, the mount 12 according to the invention can solve the problems in the prior art that the installation operation of the anchoring structure will cause structural damage and the anchoring structure can hardly be reused. In addition, in the embodiment, the mount 12 is used for supporting the satellite disk 16 (through the supporting frame 14), but the invention is not limited thereto. In practice, it is evident that the mount 12 also can be used as a supporting base for other devices, which will not be described further.

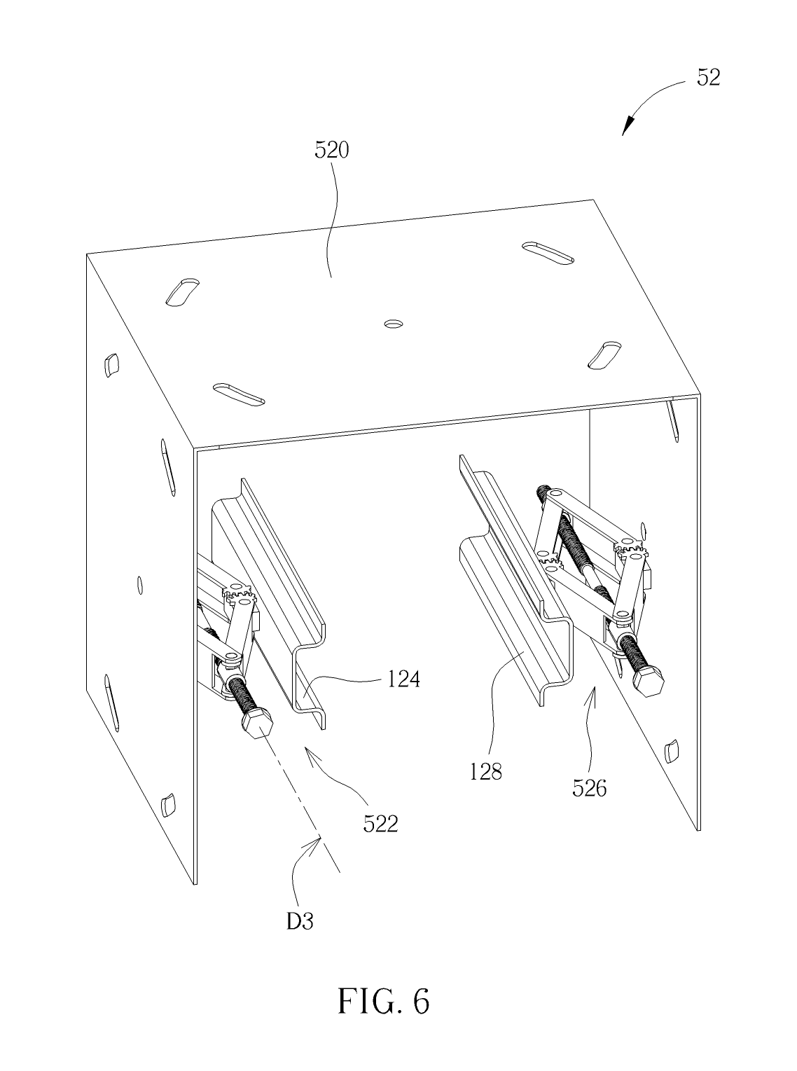

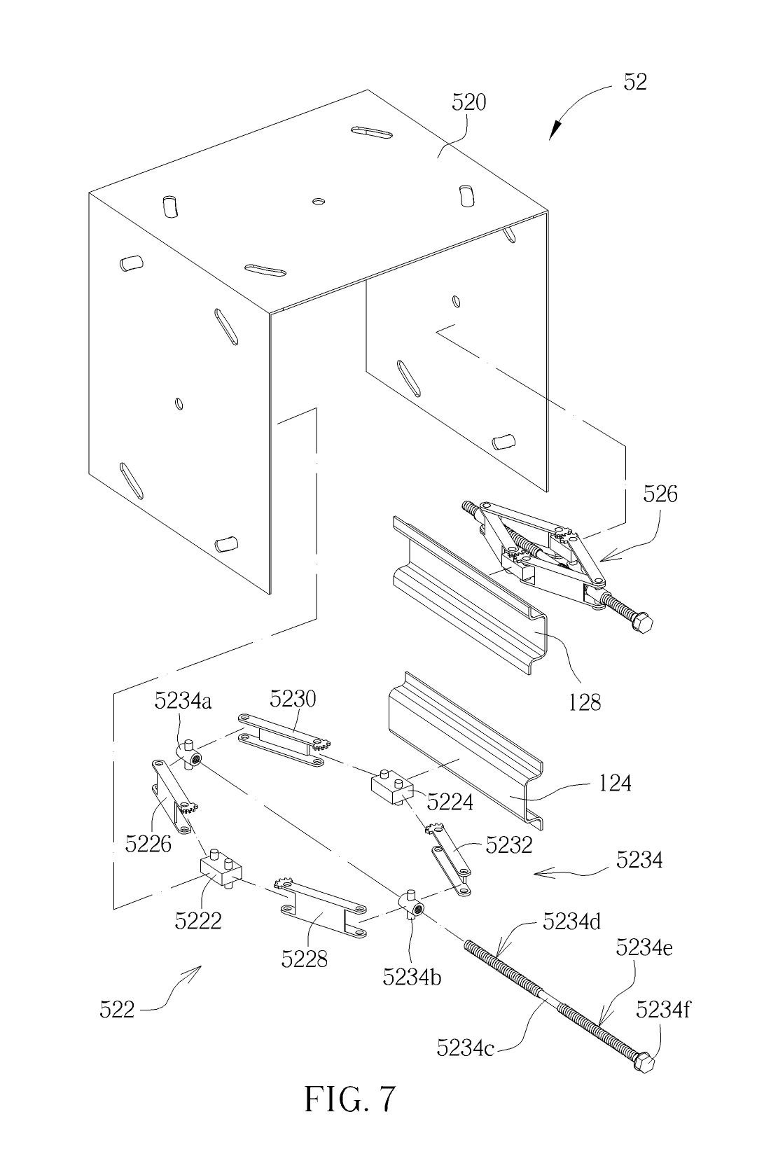

Please refer to FIG. 6 and FIG. 7. FIG. 6 is a schematic diagram illustrating a mount 52 of another embodiment according to the invention. FIG. 7 is a partially-exploded view of the mount 52. The mount 52 is structurally similar to the mount 12. Both the mounts 12 and 52 are used to be fixed across on the edge portion 22 for supporting the satellite disk 16 (through the supporting frame 14). In the following, the mount 52 uses the reference numbers of the mount 12 in principle. For other descriptions of the mount 52, please refer to the descriptions of the mount 12 and the relevant descriptions of the components with the same reference numbers, which will not repeated in addition. A difference between the mount 52 and the mount 12 is that the mount 52 uses a different adjusting mechanism. The mount 52 includes a first adjusting mechanism 522 and a second adjusting mechanism 526, oppositely disposed on the base 120. The first pressing member 124 and the second pressing member 128 are disposed on the first adjusting mechanism 522 and the second adjusting mechanism 526 respectively. The first pressing member 124 and the second pressing member 128 can be moved relative to the base 120 by operating the first adjusting mechanism 522 and the second adjusting mechanism 526. In addition, in the embodiment, for simplicity, the first adjusting mechanism 522 and the second adjusting mechanism 526 are structurally the same and symmetrically disposed on the base 120. Therefore, for descriptions of the second adjusting mechanism 526, please refer to the relevant descriptions of the first adjusting mechanism 522, which will not be repeated in addition. However, the invention is not limited thereto.

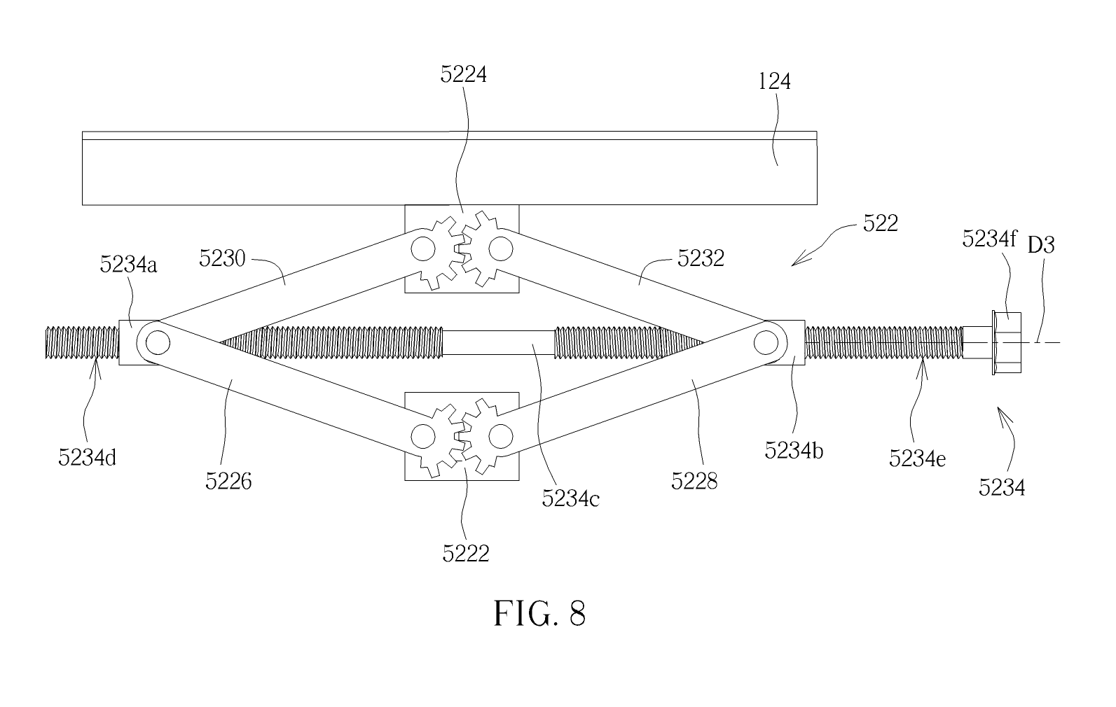

Please also refer to FIG. 8. FIG. 8 is a side view of the first adjusting mechanism 522. The first adjusting mechanism 522 includes a first connection part 5222, a second connection part 5224, a first link 5226, a second link 5228, a third link 5230, a fourth link 5232, and a length-adjustable device 5234. The length-adjustable device 5234 includes a first pivotal connection part 5234a and a second pivotal connection part 5234b. The first link 5226 is pivotally connected to the first connection part 5222 and the first pivotal connection part 5234a. The second link 5228 is pivotally connected to the first connection part 5222 and the second pivotal connection part 5234b. The first link 5226 and the second link 5228 are kinetically connected (e.g. by meshing with each other of gear structures formed on edges thereof) so that the first link 5226 and the second link 5228 simultaneously act relative to the first connection part 5222 in opposite directions. The third link 5230 is pivotally connected to the second connection part 5224 and the first pivotal connection part 5234a. The fourth link 5232 is pivotally connected to the second connection part 5224 and the second pivotal connection part 5234b. The third link 5230 and the fourth link 5232 are kinetically connected (e.g. by meshing with each other of gear structures formed on edges thereof) so that the third link 5230 and the fourth link 5232 simultaneously act relative to the second connection part 5224 in opposite directions. The base 120 is fixedly connected to the first connection part 5222. The first pressing member 124 is fixedly connected to the second connection part 5224. The length-adjustable device 5234 is operable to move the first pivotal connection part 5234a and the second pivotal connection part 5234b relatively so that the first connection part 5222 and the second connection part 5224 move relatively. For example, the first connection part 5222 and the second connection part 5224 move toward or away from each other. Thereby, the first pressing member 124 can move relative to the base 120 for the purpose of fixing the mount 52 across on the edge portion 22. In practice, the first connection part 5222 and the second connection part 5224 can be structurally integrated with the base 120 and the first pressing member 124 respectively. For example, the side portion 120b of the base 120 also serves as the first connection part 5222, and the second connection part 5224 also serves as the first pressing member 124.

In the embodiment, the length-adjustable device 5234 further includes an adjusting rod 5234c which passes through the first pivotal connection part 5234a and the second pivotal connection part 5234b. The adjusting rod 5234c has a first screw portion 5234d, a second screw portion 5234e, and a rotational manipulation portion 5234f. The first pivotal connection part 5234a and the second pivotal connection part 5234b mesh with the first screw portion 5234d and the second screw portion 5234e respectively. Therein, the thread direction of the first screw portion 5234d is opposite to the thread direction of the second screw portion 5234e. The first pivotal connection part 5234a and the second pivotal connection part 5234b include threaded hole meshing with the first screw portion 5234d and the second screw portion 5234e respectively, so that when the user rotates the adjusting rod 5234c through the rotational manipulation portion 5234f (e.g. with a wrench), the first screw portion 5234d and the second screw portion 5234e are simultaneously rotated so that the first pivotal connection part 5234a and the second pivotal connection part 5234b simultaneously move toward or away from each other relative to the adjusting rod 5234c. The position of the first pressing member 124 relative to the base 120 is adjusted accordingly, for the purpose of fixing the mount 52 across on the edge portion 22 or detaching the mount 52 from the edge portion 22. However, the length-adjustable device according to the invention is not limited to the above embodiment. For example, an end of the adjusting rod 5234c is simply pivotally connected to the first pivotal connection part 5234a. The second pivotal connection part 5234b remains connected with the adjusting rod 5234c through the threads. Thereby, the second pivotal connection part 5234b still can move relative the adjusting rod 5234c toward or away from the first pivotal connection part 5234a when the adjusting rod 5234c rotates. Therefore, the purpose of adjusting the position of the first pressing member 124 relative to the base 120 also can be achieved.

In the above embodiments, the first adjusting mechanisms 122 and 522 are realized by the different link mechanisms. In practice, the adjusting mechanism according to the invention also can be realized by other link mechanisms or devices capable of being adjusted in length or distance (i.e. adjusting the position of the first pressing member 124 relative to the base 120), so that the adjusting mechanism can move the first pressing member 124 relative to the base 120 by controlling the movement of the link mechanism or device.

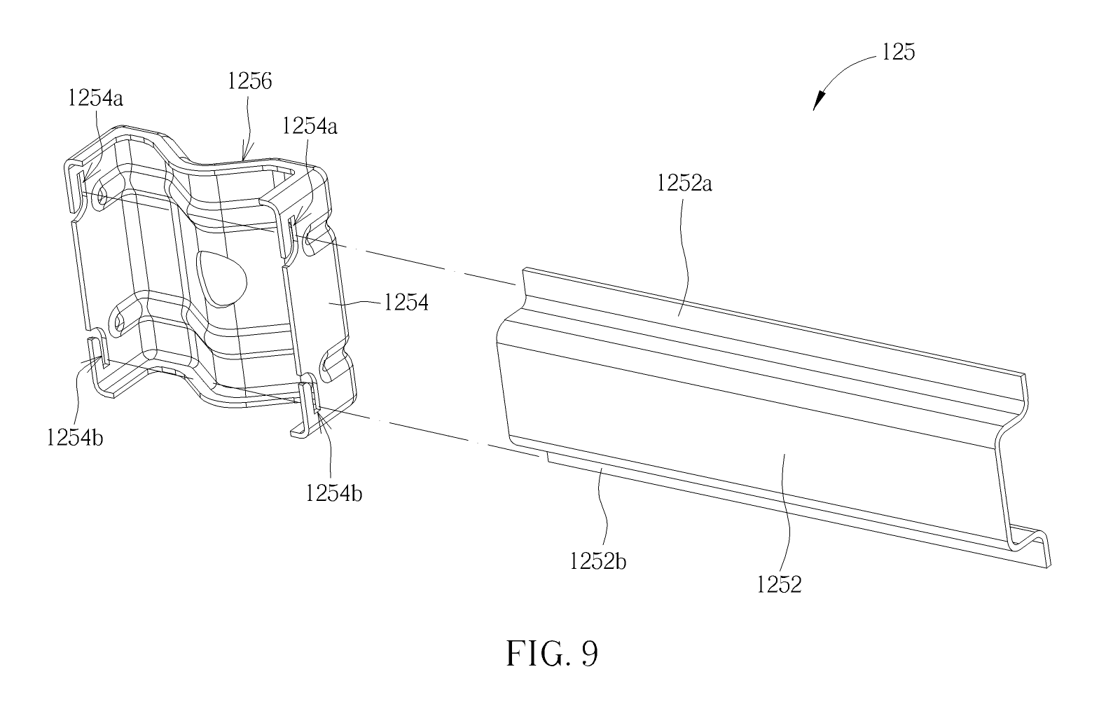

In addition, in the above embodiments, the first pressing member 124 presses a flat surface of the post 24, so the first pressing member 124 can be realized by a plate structure. If the post 24 (e.g. realized by round posts) cannot provide a flat surface for the first pressing member 124 to press thereon, the first pressing member 124 can be replaced with a pressing member 125 provided with a V-shaped recess, as shown by FIG. 9. The pressing member 125 includes a connection part 1252 and a pressing part 1254. The pressing part 1254 is slidably disposed on the connection part 1252 and has a V-shaped recess 1256. Therein, sliding slots 1254a and 1254b of the pressing part 1254 slide on sliding rails 1252a and 1252b of the connection part 1252, which facilitate a required adjustment of the position of the pressing part 1254 relative to the connection part 1252 due to a practical installation; however, the invention is not limited thereto. For example, the pressing part 1254 can be directly fixed on the connection part 1252, or the pressing member 125 is realized by a single part having the V-shaped recess 1256.

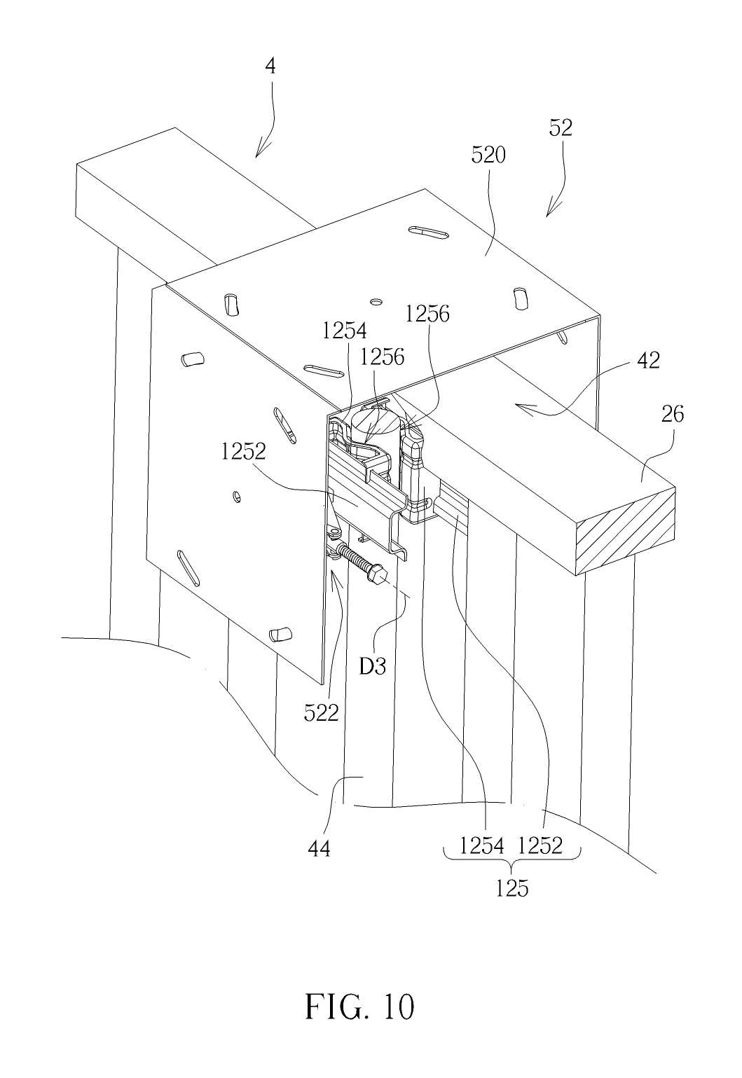

Please also refer to FIG. 10. FIG. 10 is a schematic diagram illustrating that the mount 52, of which both the first pressing member 124 and the second pressing member 128 are replaced with the pressing member 125, is fixed across on an edge portion 42 of a structural object 4. Therein, a portion of the edge portion 42 is cut off for showing the condition of the pressing member 125 relative to a round post 44 of the structural object 4. In the embodiment, for simplicity, the structural object 4 is structurally similar to the structural object 2, except for the round posts 44. The connection part 1252 is disposed on the second connection part 5224. By operating the first adjusting mechanism 522 and the second adjusting mechanism 526, the pressing members 125 can move toward each other until the post 44 gets in the V-shaped recesses 1256, so that the pressing members 125 hold the post 44 through the V-shaped recesses 1256 and clamp the edge portion 42. In practice, on condition that a post (e.g. the post 44) can at least partially get in the V-shaped recess 1256, the pressing member 125 can effectively hold the post. The post is not limited to a round post. In addition, the pressing member 125 also can be applied to the first adjusting mechanism 122 and the second adjusting mechanism 126, which will not be described in addition.

As to the mount 12, when the first adjusting mechanism 122 is operated, a rotation axis D2 (indicated by a center line in FIGS. 1, 2, 4 and 5) of the bolt 1222 is perpendicular to the arrangement direction D1 in which the plurality of posts 24 are arranged, and the first pressing member 124 is moved parallel to the rotation axis D2. Therefore, the mount 12 as a whole has a fixed dimension in the arrangement direction D1 and can applied to a case in which the installation space is limited in the arrangement direction D1. As to the mount 52, when the first adjusting mechanism 122 is operated, a rotation axis D3 (indicated by a center line in FIG. 6 and FIG. 8) of the adjusting rod 5234c is parallel to the arrangement direction D1 in which the plurality of posts 24 are arranged, and the first pressing member 124 is moved perpendicular to the rotation axis D3. Therefore, the mount 52 as a whole has a fixed dimension in a direction (perpendicular to the arrangement direction D1) in which the first pressing member 124 moves and can applied to a case in which the installation space is limited in the movement direction of the first pressing member 124.

Those skilled in the art will readily observe that numerous modifications and alterations of the device and method may be made while retaining the teachings of the invention. Accordingly, the above disclosure should be construed as limited only by the metes and bounds of the appended claims.

1. A mount used for being fixed across on an edge portion of a structural object and supporting a device, the mount comprising:
a base, on which the device is disposed;
a first adjusting mechanism disposed on the base;
a first pressing member disposed on the first adjusting mechanism, the first adjusting mechanism being operable to move the first pressing member relative to the base;
a second adjusting mechanism disposed on the base opposite to the first adjusting mechanism; and
a second pressing member disposed on the second adjusting mechanism, the second adjusting mechanism being operable to move the second pressing member relative to the base;
wherein when the base is placed on the edge portion, the first adjusting mechanism and the second adjusting mechanism can be operated to move the first pressing member and the second pressing member toward each other at two opposite sides of the edge portion to clamp the edge portion.

2. The mount of claim 1, wherein the first adjusting mechanism comprises a movable member and a matching part, the matching part is fixed on the base, the movable member is adjustably engaged with the matching part, and the first pressing member is connected to the movable member.

3. The mount of claim 2, wherein the matching part has a threaded hole, the movable member comprises a screw portion, and the screw portion meshes with the threaded hole.

4. The mount of claim 3, wherein the first pressing member is pivotally connected to the movable member.

5. The mount of claim 1, wherein the first adjusting mechanism comprises a first connection part, a second connection part, a first link, a second link, a third link, a fourth link, and a length-adjustable device, the length-adjustable device comprises a first pivotal connection part and a second pivotal connection part, the first link is pivotally connected to the first connection part and the first pivotal connection part, the second link is pivotally connected to the first connection part and the second pivotal connection part, the first link and the second link are kinetically connected so that the first link and the second link simultaneously act relative to the first connection part in opposite directions, the third link is pivotally connected to the second connection part and the first pivotal connection part, the fourth link is pivotally connected to the second connection part and the second pivotal connection part, the third link and the fourth link are kinetically connected so that the third link and the fourth link simultaneously act relative to the second connection part in opposite directions, the first connection part is fixedly connected to the base, the second connection part is fixedly connected to the first pressing member, and the length-adjustable device is operable to move the first pivotal connection part and the second pivotal connection part relatively so that the first connection part and the second connection part move relatively.

6. The mount of claim 1, wherein the first adjusting mechanism comprises a link mechanism connected between the base and the first pressing member, and the first adjusting mechanism moves the first pressing member relative to the base by controlling movement of the link mechanism.

7. The mount of claim 1, wherein the first pressing member has a V-shaped recess, and the first pressing member presses the edge portion through the V-shaped recess.

8. The mount of claim 7, wherein the first pressing member comprises a connection part and a pressing part, the connection part is disposed on the first adjusting mechanism, and the pressing part is slidably disposed on the connection part and has the V-shaped recess.

9. The mount of claim 1, wherein the base comprises a connection portion and two side portions, the two side portions are oppositely connected to the connection portion to form a reverse U-shaped structure, the base is disposed across the edge portion of the structural object through the reverse U-shaped structure, the first adjusting mechanism and the second adjusting mechanism are disposed on the two side portions respectively, and the first pressing member and the second pressing member are located between the two side portions.

10. The mount of claim 1, the edge portion comprising a plurality of posts and a rail, the plurality of posts being arranged in an interval, the rail connecting ends of the plurality of posts, wherein the first pressing member presses at least adjacent two of the posts at the same time.

11. A satellite antenna module, comprising:
a mount used for being fixed across on an edge portion of a structural object, the mount comprising:
a base;
a first adjusting mechanism disposed on the base;
a first pressing member disposed on the first adjusting mechanism, the first adjusting mechanism being operable to move the first pressing member relative to the base;
a second adjusting mechanism disposed on the base opposite to the first adjusting mechanism; and
a second pressing member disposed on the second adjusting mechanism, the second adjusting mechanism being operable to move the second pressing member relative to the base;
a supporting frame disposed on the base; and
a satellite disk disposed on the supporting frame so that the satellite disk is supported on the mount through the supporting frame;
wherein when the base is placed on the edge portion, the first adjusting mechanism and the second adjusting mechanism can be operated to move the first pressing member and the second pressing member toward each other at two opposite sides of the edge portion to clamp the edge portion.

12. The satellite antenna module of claim 11, wherein the first adjusting mechanism comprises a movable member and a matching part, the matching part is fixed on the base, the movable member is adjustably engaged with the matching part, and the first pressing member is connected to the movable member.

13. The satellite antenna module of claim 12, wherein the matching part has a threaded hole, the movable member comprises a screw portion, and the screw portion meshes with the threaded hole.

14. The satellite antenna module of claim 13, wherein the first pressing member is pivotally connected to the movable member.

15. The satellite antenna module of claim 11, wherein the first adjusting mechanism comprises a first connection part, a second connection part, a first link, a second link, a third link, a fourth link, and a length-adjustable device, the length-adjustable device comprises a first pivotal connection part and a second pivotal connection part, the first link is pivotally connected to the first connection part and the first pivotal connection part, the second link is pivotally connected to the first connection part and the second pivotal connection part, the first link and the second link are kinetically connected so that the first link and the second link simultaneously act relative to the first connection part in opposite directions, the third link is pivotally connected to the second connection part and the first pivotal connection part, the fourth link is pivotally connected to the second connection part and the second pivotal connection part, the third link and the fourth link are kinetically connected so that the third link and the fourth link simultaneously act relative to the second connection part in opposite directions, the first connection part is fixedly connected to the base, the second connection part is fixedly connected to the first pressing member, and the length-adjustable device is operable to move the first pivotal connection part and the second pivotal connection part relatively so that the first connection part and the second connection part move relatively.

16. The satellite antenna module of claim 11, wherein the first adjusting mechanism comprises a link mechanism connected between the base and the first pressing member, and the first adjusting mechanism moves the first pressing member relative to the base by controlling movement of the link mechanism.

17. The satellite antenna module of claim 11, wherein the first pressing member has a V-shaped recess, and the first pressing member presses the edge portion through the V-shaped recess.

18. The satellite antenna module of claim 17, wherein the first pressing member comprises a connection part and a pressing part, the connection part is disposed on the first adjusting mechanism, and the pressing part is slidably disposed on the connection part and has the V-shaped recess.

19. The satellite antenna module of claim 11, wherein the base comprises a connection portion and two side portions, the two side portions are oppositely connected to the connection portion to form a reverse U-shaped structure, the base is disposed across the edge portion of the structural object through the reverse U-shaped structure, the first adjusting mechanism and the second adjusting mechanism are disposed on the two side portions respectively, and the first pressing member and the second pressing member are located between the two side portions.

20. The satellite antenna module of claim 11, the edge portion comprising a plurality of posts and a rail, the plurality of posts being arranged in an interval, the rail connecting ends of the plurality of posts, wherein the first pressing member presses at least adjacent two of the posts at the same time.
